(19) United States
(12) Patent Application Publication
(10) Pub. No.: US 2021/0365920 A1
(43) Pub. Date: Nov. 25, 2021

(54) SELECTING A NETWORK TO TRANSFER FUNDS

(71) Applicant: Wells Fargo Bank, N.A., San Francisco, CA (US)

(72) Inventors: Naga Adapala, Pleasanton, CA (US); Stephen Godfrey, Palo Alto, CA (US); Michael P. Skelley, San Rafael, CA (US); Elise M. Chapman, San Francisco, CA (US); Satish Kumar Sura Venkata, Pleasanton, CA (US); Jatinder Pal Singh, Livermore, CA (US)

(21) Appl. No.: 15/269,571

(22) Filed: Sep. 19, 2016

(51) Int. Cl. G06Q 20/30; H04L 12/26

(52) U.S. Cl. CPC G06Q 20/30; H04L 43/0888

(57) ABSTRACT

A method comprises receiving, by one or more processors of a computing device and from one or more third-party servers, a request to transfer funds from a first financial account to a second financial account. The request is associated with a user account of the one or more third-party servers and comprises a plurality of parameters. The method comprises selecting, by the one or more processors and based on at least a subset of the plurality of parameters and financial-network data, a financial network, of a plurality of financial networks, over which to transfer the funds. The subset of the plurality of parameters comprises at least one of a cost priority parameter and a speed priority parameter. The financial-network data includes data associated with the plurality of financial networks. The method further comprises initiating, by the one or more processors, transfer of the funds over the selected financial network.

### TECHNICAL FIELD

The invention relates to transferring funds electronically.

### BACKGROUND

Electronic funds transfer is the electronic transfer of money from one financial account to another, either within a single financial institution or across multiple institutions, through computer-based systems. Today, a number of different networks may be used to perform funds transfers, although some networks may limit the types of transfers that may be performed and different networks may perform the transfers in a different manner.

### SUMMARY

In general, this disclosure describes techniques for selecting a financial network over which to transfer funds from one financial account to another. In order to present a robust, effective, and technically efficient system for selecting a financial network, the disclosed techniques include receiving a request to transfer funds, selecting a financial network for transferring the funds based on one or more parameters associated with the request, initiating the transfer based on the selection, and/or sending reporting information on the status of the transfer. According to the disclosed techniques, the transfer unit may be configured to select the financial network based on a cost priority parameter and/or a speed priority parameter in order to perform the transfer in accordance with the request. The transfer unit may be configured to select the network based on any suitable parameters, according to particular needs. In some examples, the request may be received from a third-party server, which may be associated with an entity that allows a user to request a transfer of funds between financial accounts and is separate from the entity that performs the described technique. The entity may be an entity that allows a user to request a transfer of funds to another party (e.g., Uber™, Lyft™, Etsy™, Airbnb™, eBay™, etc., or any other service that facilitates transactions between parties).

In one example, this disclosure is directed to a computing device comprising one or more storage units and one or more processors in communication with the storage units. The one or more processors are configured to receive, from one or more third-party servers, a request to transfer funds from a first financial account to a second financial account. The request is associated with a user account of the one or more third-party servers. The request comprises a plurality of parameters. The first and second financial accounts are associated with one or more servers that are different than the third-party server. The one or more processors are further configured to select, based on at least a subset of the plurality of parameters and financial-network data, a financial network, of a plurality of financial networks, over which to transfer the funds. The subset of the plurality of parameters comprises at least one of a cost priority parameter and a speed priority parameter. The financial-network data includes data associated with the plurality of financial networks. The one or more processors are further configured to initiate a transfer of the funds over the selected financial network.

In another example, this disclosure is directed to a method comprising receiving, by one or more processors of a computing device and from one or more third-party servers, a request to transfer funds from a first financial account to a second financial account. The request is associated with a user account of the one or more third-party servers. The request comprises a plurality of parameters. The first and second financial accounts are associated with one or more servers that are different than the third-party server. The method further comprises selecting, by the one or more processors and based on at least a subset of the plurality of parameters and financial-network data, a financial network, of a plurality of financial networks, over which to transfer the funds. The subset of the plurality of parameters comprises at least one of a cost priority parameter and a speed priority parameter. The financial-network data includes data associated with the plurality of financial networks. The method further comprises initiating, by the one or more processors, transfer of the funds over the selected financial network.

In a further example, this disclosure is directed to a non-transitory computer-readable storage medium having stored thereon instructions that, when executed, cause a processor to receive, from one or more third-party servers, a request to transfer funds from a first financial account to a second financial account. The request is associated with a user of the one or more third-party servers. The request comprises a plurality of parameters, wherein the first and second financial accounts are associated with one or more servers that are different than the third-party server. The instructions, when executed, further cause the processor to select, based on at least a subset of the plurality of parameters and financial-network data, a financial network, of a plurality of financial networks, over which to transfer the funds. The subset of the plurality of parameters comprises at least one of a cost priority parameter and a speed priority parameter. The financial-network data includes data associated with the plurality of financial networks. The instructions, when executed, further cause the processor to initiate a transfer of the funds over the selected financial network.

The details of one or more examples of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example transfer system that includes a transfer unit configured to receive a request to transfer funds, select a network by which to transfer the funds, and initiate the transfer over the network, in accordance with the techniques of this disclosure.

FIG. 2 is a block diagram illustrating an example computing device of FIG. 1 in further detail.

FIG. 3 is a flowchart illustrating an example operation of a transfer unit running on a computing device of the transfer system, in accordance with the techniques of this disclosure.

### DETAILED DESCRIPTION

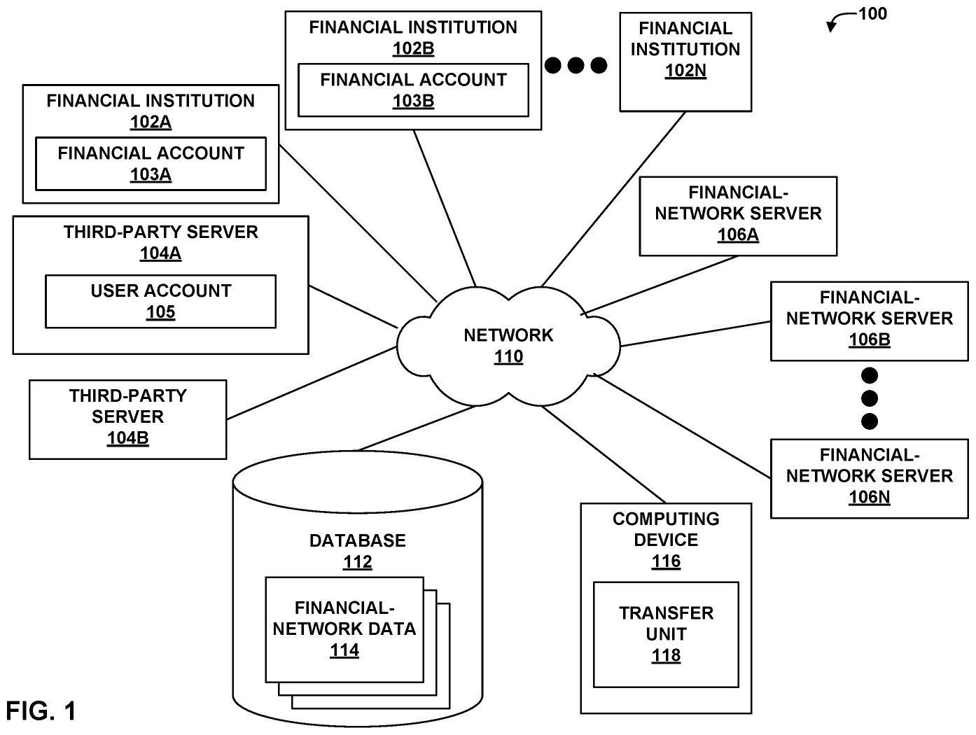

FIG. 1 is a block diagram illustrating an example transfer system 100 that includes a transfer unit 118 configured to receive a request to transfer funds, select a network by which to transfer the funds, and initiate the transfer over the network, in accordance with the techniques of this disclosure.

In this example, transfer system 100 includes computing device 116, database 112, financial institutions 102A-102N, third-party servers 104A and 104B, and financial-network servers 106A-106N in communication with each other via network 110. Database 112 may store financial-network data 114. Computing device 116 may include transfer unit 118. Although FIG. 1 illustrates two third-party servers 104A and 104B and one administrator computer 116, in other examples transfer system 100 may include one or more of any of third-party servers 102 and computing device 116.

Network 110 may comprise a private network including, for example, a private network associated with an organization, or may comprise a public network, such as the Internet. Although illustrated in FIG. 1 as a single entity, in other examples network 110 may comprise a combination of public and/or private networks.

Financial institutions 102 may be, for example, a traditional bank, credit union, or credit card company, or any other organization that maintains financial accounts for use by a customer.

Financial accounts 104 may be accounts, such as a checking, savings, or credit account associated with and serviced by a financial institution 102 and associated with one or more customers who may deposit, withdrawal, and make payments to and from the financial account 104. In the illustrated example, financial account 104a may be associated with financial institution 102a and financial account 104b may be associated with financial institution 102b.

Third-party servers 104 may be one or more servers storing information associated with one or more third parties, including merchant service providers, such as, for example, (e.g., Uber™, Lyft™, Etsy™, Airbnb™, eBay™, etc., or any other service that facilitates transactions between parties). Third-party servers 104 may be configured to generate, store, transmit, and/or report the status of requests to transfer funds between financial accounts 104.

User account 105 may be an account associated with the third-party server 104. For example, a user of a merchant service may have a user account 105 that allows the user to log-in to the access the merchant service and perform different functions using the service including, for example, requesting transfer of funds between different financial accounts.

Financial-network servers 106 may be one or more servers for storing and transmitting information for transferring funds between financial accounts 104. For example, financial-network servers 106 may be associated with one or more financial networks for transferring funds including, for example, Automated Clearing House™, International Automated Clearing House™, Faster Payments™, Bacs, SWIFT™ international payment network, Fedwire Funds Transfer System™, SurePay™, PayPal™, Bitcoin™, or any other suitable network for transferring funds.

Database 112 may be a data structure for storing data related to the transfer system 100 including financial-network data 114. Database 112 may be stored by any suitable party and in any suitable location according to particular needs. For example, database 112 may be stored and maintained by an organization associated with transfer system 100 or by a third-party vendor that stores and maintains data. Although illustrated as a single database 112, any suitable number of databases may be used for storing the data described according to particular needs. Although shown as being separate from computing device 116, in certain examples, database 112 may be stored and executed within computing device 116.

Financial-network data 114 stored in database 112 may include information regarding financial networks that may be available for transferring funds and the rules for transferring funds through particular financial networks. For example, financial-network data 114 may store data related to any suitable financial networks including, for example, Automated Clearing House™, International Automated Clearing House™, Faster Payments™, Bacs, SWIFT™ international payment network, Fedwire Funds Transfer System™, SurePay™, PayPal™, Bitcoin™, or any other suitable network for transferring funds. Financial-network data 114 may include, for example, credit and/or funding limits, ensuring sufficient funds to perform the requested transfer, availability and authorization of one or more financial networks at the time of the requested transfer and/or network rules governing the eligibility of payment types and/or network participants. Financial-network data 114 may include rules indicating when particular financial networks may be used for transferring funds. For example, financial-network data 114 may specify, for one or more of the financial networks, a minimum transfer amount for transferring funds through the network. As another example, only certain financial networks may be available for transfers to and/or from particular financial accounts and/or for transfers to and/or from financial accounts associated with particular currencies. Financial-network data 114 may additionally store information regarding the cost and speed of transferring money using any particular network. In some examples, the cost and/or speed for any particular network may be dependent on other factors including, for example, the transfer amount, the type of or particular financial account and/or intended recipient that the funds are transferred to or from, the location and/or currency associated with the financial account that the funds are transferred to or from, the purpose of the transfer, the availability of all necessary information to complete the transfer on the selected network, the speed of transfer, and/or the cost of the transfer. Financial-network data 114 may be updated periodically according to particular needs.

Computing device 116 may be associated with one or more organizations including, for example, a corporation or other organization. Computing device 116 may be a centralized computing device configured to execute transfer unit 118 for selecting a financial network over which to transfer funds between financial accounts 104. Computing device 116 may comprise a cluster of one or more computers, workstations, servers, and the like. Computing device 116 configured to execute transfer unit 118 may be physically or virtually included within an internal network of an organization. Alternatively, computing device 116 configured to execute transfer unit 118 may be physically or virtually included in a network hosted by a third-party vendor. For example, a vendor of an organization may store and maintain transfer unit 118 for an organization and/or may provide the functions of transfer unit 118 as a service to an organization.

Transfer unit 118 executed by computing device 116 may receive and analyze a request to transfer funds to select a network over which to transfer the funds. Transfer unit 118 may use financial-network data 114 to select a financial network based on one or more parameters in the request including, for example, a cost priority parameter, a speed priority parameter, and/or any other suitable parameter for choosing a financial network. Transfer unit 118 may initiate the transfer based on the selection by sending a request to a financial-network server 106A or 106B to transfer the funds. In this way, transfer unit 118 may choose from a large number of financial networks to the available financial network that best satisfies the parameters of the request.

In some examples, transfer unit 118 executed by computing device 116 may also provide reporting on a status of a transfer. For example, transfer unit 118 may provide reporting to indicate one or more of the network selected, the cost of the transfer, confirmation that all necessary payment information to complete the transfer is available, the results of other validation and verification steps (e.g., Office of Foreign Assets Control (OFAC) and/or other sanctions screening), the progress of the transfer through the network (e.g., which computing device or server is currently processing the request), the success or failure in delivering funds to the intended recipient, and/or the reason(s) resulting in a failed delivery. Reporting data may be sent to one or more computing devices for display to a user or administrator. For example, a user requesting the transfer may be able to view the reporting information on a user interface of a computing device. As another example, an intended recipient may be able to view the reporting information on a user interface of a computing device.

Certain techniques of this disclosure may, in some instances, provide a technical solution to selecting a financial network by which to transfer funds in a manner that is robust and efficient. For example, transfer unit 118 may gather and analyze large amounts of data from multiple sources to more efficiently determine available networks and, from those available networks, choose the network that optimally meets cost and/or speed preferences associated with the request. This may result in more efficient and effective transfer of funds and may therefore result in reduction in required resources, including human, capital, and technological resources. For example, the system may eliminate or reduce attempts at transferring funds via inadequate and/or unavailable networks and may therefore limit processing resources needed for fails and/or unsatisfactory attempts. As another example, the system may choose from a wider option of networks than may otherwise be possible, such that more efficient transfers may be made than would otherwise be possible, thus limiting processing resources for performing transfers.

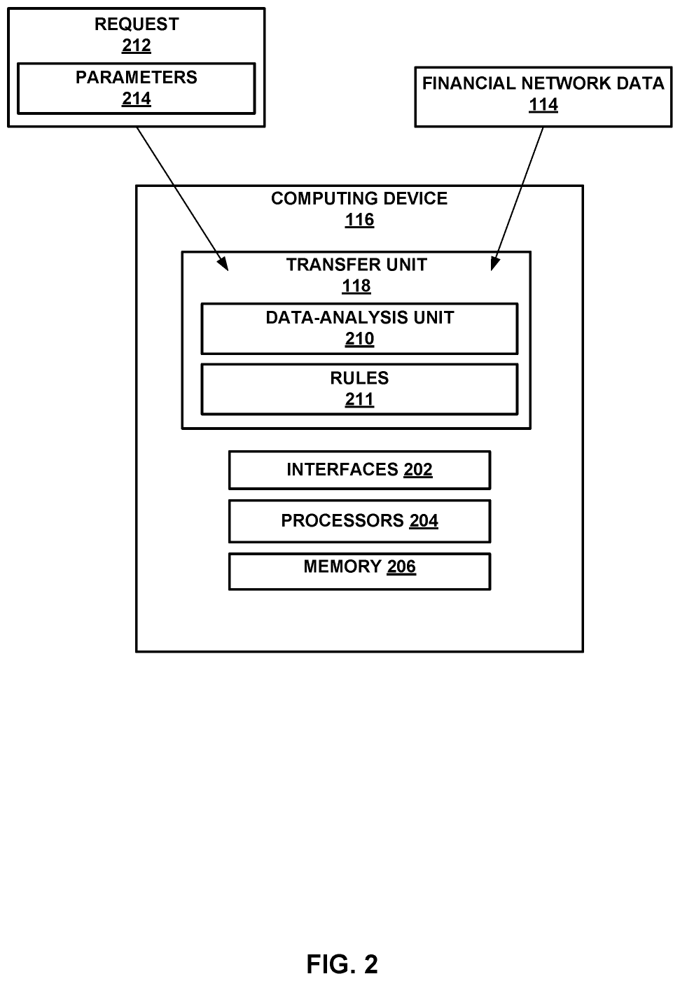

FIG. 2 is a block diagram illustrating an example computing device 116 of FIG. 1 in further detail. Computing device 116 may include transfer unit 118 of FIG. 1, interfaces 202, processors 204, memory 206, and displays 208.

Computing device 116 may include one or more interfaces 202 for allowing transfer unit 118 to communicate with one or more databases (e.g., database 112), servers (e.g. third-party servers 102 and/or financial-network servers 106), devices and/or networks via one or more networks, e.g. network 110. The one or more interfaces 202 may include one or more network interface cards, such as Ethernet cards, and/or any other types of interface devices that can send and receive information. In some examples, transfer unit 118 utilizes the one or more interfaces 202 to communicate with database 112, third-party servers 102, financial-network servers 106 and/or any other suitable device. Any suitable number of interfaces may be used to perform the described functions according to particular needs.

Computing device 116 may include one or more processors 204 configured to implement functionality and/or process instructions for execution within transfer unit 118. Processors 204 may include, for example, microprocessors, digital signal processors (DSPs), application specific integrated circuits (ASICs), field-programmable gate arrays (FPGAs), and/or equivalent discrete or integrated logic circuitry.

Computing device 116 may include memory 206 configured to store information within computing device 116. Memory 206 may include a computer-readable storage medium or computer-readable storage device. In some examples, memory 206 may include one or more of a short-term memory or a long-term memory. Memory 206 may include, for example, random access memories (RAM), dynamic random access memories (DRAM), static random access memories (SRAM), magnetic hard discs, optical discs, floppy discs, flash memories, or forms of electrically programmable memories (EPROM), or electrically erasable and programmable memories (EEPROM). In some examples, memory 206 may store logic (e.g., logic of transfer unit 118) for execution by one or more processors 204. In further examples, memory 206 may be used by transfer unit 118 to temporarily store information during program execution.

Transfer unit 118 may include instructions executed by one or more processors 204 of computing device 116 to perform the functions of transfer unit 118 as described herein. Transfer unit 118 may include rules 211 for selecting a financial network over which to transfer funds based on information retrieved from database 112, third-party servers 102, financial-network servers 106, and/or any other suitable information for determining a recommended action.

Transfer unit 118 may access, via network 110, a request 212 to transfer funds. For example, computing device 116 may receive, by one or more interfaces 202 and from one or more devices including, for example, third-party server 102A or 102B, a request 212 to transfer funds from a first financial account 103A to a second financial account 103B. The received request may include, for example, a plurality of parameters 214.

The plurality of parameters 214 may include an identification of the first financial account 103A and/or an identification of the second financial account 103B. For example, the identification may include a routing and/or account number, credit card information associated with the account, or any other suitable information for identifying a financial account. The plurality of parameters 214 may include an amount of the funds to be transferred. For example, the request 212 may indicate an amount, whether in dollars or some other currency, to be transferred. The plurality of parameters 214 may include a currency associated with the first financial account 103A and/or a currency associated with the second financial account 103B. For example, the request 212 may indicate that a currency associated with the first financial 103A account is U.S. dollars and that a currency associated with the second financial 103B account may be in British pounds sterling.

In some examples, the plurality of parameters 214 may include, for example a cost parameter and/or a speed parameter. A cost priority parameter may indicate that the funds are to be transferred at the lowest possible cost. For example, the cost priority parameter may indicate that, of all the available networks for completing the transfer, as may be determined by one or more other parameters such as any of the parameters above or any other suitable parameters, the least expensive option should be used. A speed priority parameter may indicate that the funds are to be transferred at the fastest possible speed. For example, the speed priority parameter may indicate that, of all the available networks for completing the transfer, as may be determined by one or more other parameters such as any of the parameters above or any other suitable parameters, the fastest option should be used.

The available networks may be limited by any suitable parameters, such as any of the parameters identified above. For example, only certain networks may be available for a given amount to be transferred, depending on the financial accounts between which the transfer will be made, the currency associated with either or both of the financial accounts, and/or any other suitable parameter. In some examples, the cost priority parameter may indicate a range of acceptable costs for transferring the funds. For example, the cost parameter may indicate that any cost up to a particular amount is acceptable. In some examples, a speed priority parameter indicates that the funds are to be transferred at the quickest possible speed. For example, the speed priority parameter may indicate that, of all the available networks for completing the transfer, the fastest option should be used. In some examples, a speed priority parameter may indicate a range of acceptable speeds for transferring the funds. For example, the speed parameter may indicate that any speed up to a maximum transfer time may be acceptable. In some examples, the plurality of parameters may include a combination of cost and speed parameters. For example, the cost parameter and speed parameters may indicate that any cost up to a particular amount is acceptable and that the fastest option that falls within the acceptable range of costs should be chosen. As another example, the speed and cost parameters may indicate that any speed up to a maximum transfer time may be acceptable and that the least expensive option that falls within the acceptable range of transfer times should be chosen. These parameters may be used by the transfer unit 118 to select the network over which to transfer the funds.

Transfer unit 118 may also access, via network 110, financial-network data 114. For example, computing device 118 includes one or more interfaces 202 and may receive, by the one or more interfaces 202 and from database 112, financial-network data 114. The received financial-network data 114 may include, information regarding financial networks that may be available for transferring funds and the rules for transferring funds through particular financial networks. For example, financial-network data 114 may store data related to any suitable financial networks including, for example, Automated Clearing House™ International Automated Clearing House™, Faster Payments™, Bacs, SWIFT™ international payment network, Fedwire Funds Transfer System™, SurePay™, PayPal™, Bitcoin™, or any other suitable network for transferring funds.

Financial-network data 114 may indicate when particular financial networks may be used for transferring funds. For example, financial-network data 114 may specify, for one or more of the financial networks, a minimum transfer amount for transferring funds through the network. As another example, only certain financial networks may be available for transfers to and/or from particular financial accounts and/or for transfers to and/or from financial accounts associated with particular currencies and/or certain individuals, entities or qualified participants. Financial-network data 114 may include credit or funding limits, such that transactions through a given financial network may be limited by the amount of funds and/or credit associated with the financial account from which funds are to be transferred. Financial-network data 114 may also include information indicating which of a plurality of financial networks are currently available and/or authorized at the time of the requested transfer. Financial-network data 114 may additionally store information regarding the cost and speed of transferring money using any particular financial account. In some examples, the cost and/or speed of a particular network may be dependent on other factors including, for example, the transfer amount, the type of or particular financial account that the funds are transferred to or from, the location and/or currency associated with the financial account that the funds are transferred to or from, the speed or transfer, and/or the cost of the transfer.

In operation, according to aspects of this disclosure, transfer unit 118 may be used to select a financial network over which to transfer funds based on parameters in a request to transfer funds and based on financial-network data 114.

Transfer unit 118 may include a data-analysis unit 210 for analyzing data including, for example, a request and financial-network data 114. Data-analysis unit 210 may, for example, select a network that optimally meets the parameters of a transfer request based on the parameters of the request and on financial-network data 114. For example, data-analysis unit 210 may determine available financial networks available for performing the transfer and, of the available financial networks, choose the network that optimally performs the transfer based on, for example, a cost priority parameter and/or a speed priority parameter.

Data-analysis unit 210 may determine available financial networks based on financial-network data 114 indicating when particular financial networks may be used for transferring funds. For example, financial-network data 114 may specify, for one or more of the financial networks, a minimum transfer amount for transferring funds through the network. As another example, only certain financial networks may be available for transfers to and/or from particular financial accounts and/or for transfers to and/or from financial accounts associated with particular currencies. As another example, only certain financial networks may be available and/or authorized for use during the requested transfer time. Based on the financial-network data 114 and the parameters 214 in the request 212, data-analysis unit 210 may determine the available financial networks.

From the available financial networks, data-analysis unit 210 may choose the financial network that that optimally performs the transfer based on, for example, a cost priority parameter and/or a speed priority parameter and financial-network data 114. For example, financial-network data 114 may store information regarding the cost and speed of transferring money using any particular financial account. In some examples, the cost and/or speed of a particular network may be dependent on other factors including, for example, the transfer amount, the type of or particular financial account that the funds are transferred to or from, the location and/or currency associated with the financial account that the funds are transferred to or from, the speed or transfer, and/or the cost of the transfer. Based on a cost priority parameter and/or a speed priority parameter and the financial-network data 114, data-analysis unit 210 may choose the available network that will best fit the cost priority parameter and/or the speed priority parameter.

In some examples, transfer unit 118 may initiate the transfer over the selected network. For example, transfer unit 118 may send a request to a financial-network server 106A or 106B to make the transfer.

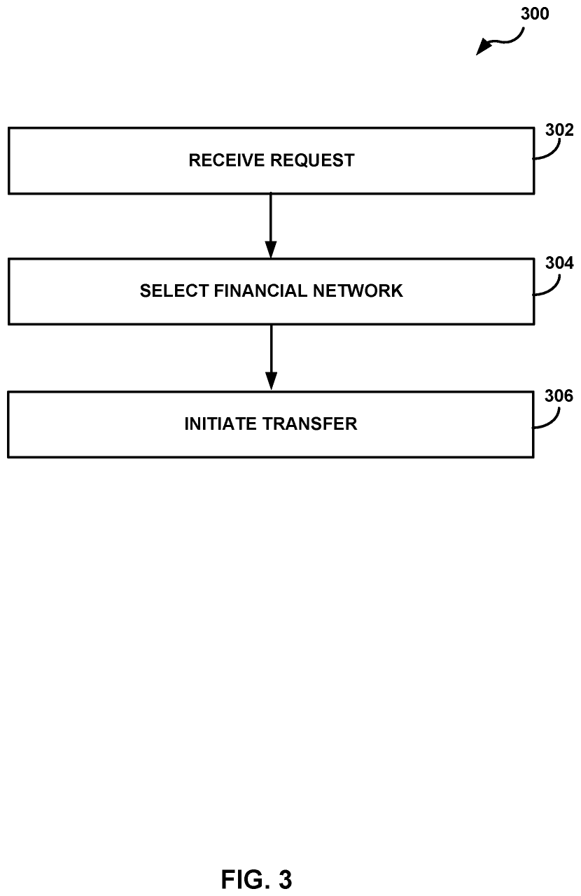

FIG. 3 is a flowchart illustrating an example operation 300 of transfer unit 118 running on computing device 116 of the transfer system 100, in accordance with the techniques of this disclosure. The example operation 300 is described with respect to transfer unit 118 of computing device 116 of FIG. 1.

Transfer unit 118 may receive a request to transfer funds (302). For example, transfer unit 118 may receive, from third-party servers 102A, a request to transfer funds from a first financial account 103A to a second financial account 103B. The request may be associated with a user account 105 associated with third-party server 102A. For example, third-party server 102A may be associated with a merchant service (e.g., Uber™, Lyft™, Etsy™ Airbnb™, eBay™, etc., or any other service that facilitates transactions between parties), and the request may associated with a user account 105 associated with the merchant service. For example, a user of the merchant service may have a user account 105 and may initiate the request to transfer funds using the user account 105. For example, while logged-in to the user account 105, the user may use a user device to input and send the request to third-party server 102A. Third-party server 102A may then send the request to transfer unit 118 and transfer unit 118 may receive the request from third-party server 102A.

The request may comprise a plurality of parameters. The plurality of parameters may include an identification of the first financial account 103A and/or an identification of the second financial account 103B. For example, the identification may include a routing and/or account number, credit card information associated with the account, or any other suitable information for identifying a financial account. The plurality of parameters may include an amount of the funds to be transferred. For example, the request may indicate an amount, whether in dollars or some other currency, to be transferred. The plurality of parameters may include a currency associated with the first financial account 103A and/or a currency associated with the second financial account 103B. For example, the request may indicate that a currency associated with the first financial account 103A is U.S. dollars and that a currency associated with the second financial account 103B may be in British pounds sterling.

In some examples, the plurality of parameters may include, for example a cost parameter and/or a speed parameter. A cost priority parameter may indicate that the funds are to be transferred at the lowest possible cost. For example, the cost priority parameter may indicate that, of all the available networks for completing the transfer, the least expensive option should be used. The available networks may be limited by other parameters, such as any of the parameters identified above. For example, only certain networks may be available for a given amount to be transferred, depending on the financial accounts between which the transfer will be made, the currency associated with either or both of the financial accounts, and/or any other suitable parameter. In some examples, the cost priority parameter may indicate a range of acceptable costs for transferring the funds. For example, the cost parameter may indicate that any cost up to a particular amount is acceptable. In some examples, a speed priority parameter indicates that the funds are to be transferred at the quickest possible speed. For example, the speed priority parameter may indicate that, of all the available networks for completing the transfer, the fastest option should be used. In some examples, a speed priority parameter may indicate a range of acceptable speeds for transferring the funds. For example, the speed parameter may indicate that any speed up to a maximum transfer time may be acceptable. In some examples, the plurality of parameters may include a combination of cost and speed parameters. For example, the cost parameter and speed parameters may indicate that any cost up to a particular amount is acceptable and that the fastest option that falls within the acceptable range of costs should be chosen. As another example, the speed and cost parameters may indicate that any speed up to a maximum transfer time may be acceptable and that the least expensive option that falls within the acceptable range of transfer times should be chosen.

Transfer unit 118 may select, based on at least a subset of the plurality of parameters 214 and based on financial-network data 114, a financial network, of a plurality of financial networks, over which to transfer the funds (304). The subset of the plurality of parameters may comprise at least one of a cost priority parameter and a speed priority parameter.

The plurality of networks may include, for example, Automated Clearing House, International Automated Clearing House, Faster Payments, Bacs, SWIFT international payment network, Automated Clearing House™, International Automated Clearing House™, Faster Payments™, Bacs, SWIFT™ international payment network, Fedwire Funds Transfer System™, SurePay™, PayPal™, Bitcoin™, or any other suitable network for transferring funds.

From the available networks, transfer unit 119 may choose the network that would optimally perform the transfer based on a cost priority parameter and/or a speed priority parameter.

Transfer unit 118 may initiate a transfer of the funds over the selected financial network (306). For example, transfer unit 118 may send a request to a server associated with the selected financial network, such as financial-network server 106A or 106B, to transfer the funds from the first financial account 103A to the second financial account 103B.

In some examples, example operation 300 may include more or fewer steps. For example, in some examples, transfer unit 118 executed by computing device 116 may also provide reporting on a status of a transfer. For example, transfer unit 118 may provide reporting to indicate one or more of the network selected, the cost of the transfer, confirmation that all necessary payment information to complete the transfer is available, the results of other validation and verification steps (e.g., Office of Foreign Assets Control (OFAC) and/or other sanctions screening), the progress of the transfer through the network (e.g., which computing device or server is currently processing the request), the success or failure in delivering funds to the intended recipient, and/or the reason(s) resulting in a failed delivery. Transfer unit 118 may send reporting data to one or more computing devices for display to a user or administrator. For example, a user requesting the transfer may be able to view the reporting information on a user interface of a computing device. As another example, an intended recipient may be able to view the reporting information on a user interface of a computing device.

In some examples, example operation 300 may include steps performed in any particular order according to particular needs. Although the illustrated example described transferring funds between financial accounts 103A and 103, which are each associated with different financial institutions 102A and 102B, the method may include transferring funds between financial accounts associated with the same financial institution.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Techniques of this disclosure may provide one or more technical advantages. For example, certain techniques of this disclosure may, in some instances, provide a technical solution to selecting a financial network by which to transfer funds in a manner that is robust and efficient. For example, transfer unit 118 may gather and analyze large amounts of data from multiple sources to more efficiently determine available networks and, from those available networks, choose the network that optimally meets cost and/or speed preferences associated with the request. This may result in more efficient and effective transfer of funds and may therefore result in reduction in required resources, including human, capital, and technological resources. For example, the system may eliminate or reduce attempts at transferring funds via inadequate and/or unavailable networks and may therefore limit processing resources needed for fails and/or unsatisfactory attempts. As another example, the system may choose from a wider option of networks than may otherwise be possible, such that more efficient transfers may be made than would otherwise be possible, thus limiting processing resources for performing transfers.

Various examples have been described. These and other examples are within the scope of the following claims.

1. A computing device comprising:
one or more storage units; and
one or more processors in communication with the storage units and configured to:
receive one or more transfer preferences for a user, wherein the one or more transfer preferences include at least one of a cost priority parameter or a speed priority parameter;
periodically request, from one or more financial-network servers of a plurality of financial networks, rules indicating conditions for transferring funds through particular financial networks of the plurality of financial networks, wherein the rules indicating conditions for transferring funds comprise at least one of a minimum transfer amount, a maximum transfer amount, a type of financial account, or an accepted currency of the funds;
receive, from one or more third-party servers, a request to transfer funds from a first financial account of the user to a second financial account, wherein the request is associated with a user account of the user at the one or more third-party servers, wherein the request comprises a plurality of parameters comprising a transfer amount of the funds, a type of the first financial account, a type of the second financial account, a location of the first financial account, a location of the second financial account, and a currency of the funds, and wherein the first and second financial accounts are associated with one or more servers that are different than the third-party server;
determine one or more available financial networks from the plurality of financial networks for which at least a subset of the plurality of parameters included in the request to transfer funds satisfy the rules indicating conditions for transferring funds through particular financial networks, and wherein the plurality of financial networks comprises more than one type of electronic funds transfer (ETF) network;
select a financial network of the one or more plurality of available financial networks over which to transfer the funds based on the at least one of the cost priority parameter or the speed priority parameter received from the user and financial-network data of the one or more available financial networks, wherein the financial-network data includes data associated with a cost or a speed of transferring funds using a particular financial network of the one or more plurality of available financial networks;
instruct the selected financial network to transfer the funds from the first financial account to the second financial account; and
report, to the one or more third party servers, at least one of the selected financial network, a cost of the transfer, or confirmation that all necessary payment information to complete the transfer is available.

2. The computing device of claim 1, wherein the plurality of parameters comprises at least one of data that identifies the first financial account, data that identifies the second financial account, an amount of the funds to be transferred, a currency associated with the first financial account, and a currency associated with the second financial account.

3. The computing device of claim 1, wherein the cost priority parameter indicates that the funds are to be transferred at a lowest cost of the one or more available financial networks, such that to select the financial network, the one or more processors select a financial network, of the one or more available financial networks having the lowest cost.

4. The computing device of claim 1, wherein the speed priority parameter indicates that the funds are to be transferred at a fastest speed of the one or more available financial networks, such that to select the financial network, the one or more processors select a financial network, of the one or more available financial networks having the fastest speed.

5. The computing device of claim 1, wherein the cost priority parameter indicates a range of acceptable costs for transferring the funds, such that to select the financial network, the one or more processors select a financial network, of the one or more available financial networks having a cost within the range of acceptable costs.

6. The computing device of claim 1, wherein the speed priority parameter indicates a range of acceptable speeds for transferring the funds, such that to select the financial network, the one or more processors select a financial network, of the one or more available financial networks having a speed within the range of acceptable speeds.

7. The computing device of claim 1, wherein the plurality of networks comprises at least one of:
Automated Clearing House;
International Automated Clearing House;
Faster Payments;
Bacs,
SWIFT international payment network;
Fedwire Funds Transfer System;
SurePay;
PayPal; or
Bitcoin.

8. The computing device of claim 1, wherein at least some of the plurality of parameters are generated by a user when the user generates the request.

9. (canceled)

10. The computing device of claim 1, wherein the one or more processors are further configured to select the subset of parameters from the plurality of parameters that will narrow a number of available financial networks of the one or more financial networks.

11. The computing device of claim 1, wherein the one or more processors are further configured to select the subset of parameters from the plurality of parameters that change a list of available financial networks of the plurality of financial networks.

12. The computing device of claim 1, wherein the one or more processors are further configured to select the largest subset of parameters from the plurality of parameters that may be satisfied for the request.

13. A method comprising:
receiving, by one or more processors of a computing device, one or more transfer preferences for a user, wherein the one or more transfer preferences include at least one of a cost priority parameter or a speed priority parameter;
periodically requesting, by the one or more processors and from one or more financial-network servers of a plurality of financial networks, rules indicating conditions for transferring funds through particular financial networks of the plurality of financial networks, wherein the rules indicating conditions for transferring funds comprise at least one of a minimum transfer amount, a maximum transfer amount, a type of financial account, or an accepted currency of the funds;
receiving, by the one or more processors and from one or more third-party servers, a request to transfer funds from a first financial account of the user to a second financial account, wherein the request is associated with a user account of the user at the one or more third-party servers, wherein the request comprises a plurality of parameters comprising a transfer amount of the funds, a type of the first financial account, a type of the second financial account, a location of the first financial account, a location of the second financial account, and a currency of the funds, and and wherein the first and second financial accounts are associated with one or more servers that are different than the third-party server;
determine, by the one or more processors one or more available financial networks from the plurality of financial networks for which the at least a subset of the plurality of parameters included in the request to transfer funds satisfy the rules indicating conditions for transferring funds through particular financial networks, and wherein the plurality of financial networks comprises more than one type of electronic funds transfer (ETF) network;
selecting, by the one or more processors, a financial network of the one or more available financial networks over which to transfer the funds based on the at least one of the cost priority parameter or the speed priority parameter received from the user and financial-network data of the one or more available financial networks, wherein the financial-network data includes data associated with a cost or a speed of transferring funds using a particular financial network of the one or more available financial networks;
initiating, by the one or more processors, transfer of the funds over the selected financial network by sending a request to the selected financial network to transfer the funds from the first financial account to the second financial account; and
reporting, by the one or more processors and to the one or more third party servers, at least one of the selected financial network, a cost of the transfer, or confirmation that all necessary payment information to complete the transfer is available.

14. The method of claim 13, wherein the plurality of parameters comprises at least one of data that identifies the first financial account, data that identifies the second financial account, an amount of the funds to be transferred, a currency associated with the first financial account, and a currency associated with the second financial account.

15. The method of claim 13, wherein the cost priority parameter indicates that the funds are to be transferred at a lowest cost of the one or more available financial networks, such that to select the financial network, the one or more processors select a financial network, of the one or more available financial networks having the fastest speed.

16. The method of claim 13, wherein the speed priority parameter indicates that the funds are to be transferred at a fastest speed of the one or more available financial networks, such that to select the financial network, the one or more processors select a financial network, of the one or more available financial networks having the fastest speed.

17. A non-transitory computer-readable storage medium having stored thereon instructions that, when executed, cause one or more processors to:
receive one or more transfer preferences for a user, wherein the one or more transfer preferences include at least one of a cost priority parameter or a speed priority parameter;
periodically request, from one or more financial-network servers of a plurality of financial networks, rules indicating conditions for transferring funds through particular financial networks of the plurality of financial networks, wherein the rules indicating conditions for transferring funds comprise at least one of a minimum transfer amount, a maximum transfer amount, a type of financial account, or an accepted currency of the funds;
receive, from one or more third-party servers, a request to transfer funds from a first financial account of the user to a second financial account, wherein the request is associated with a user account of the user at the one or more third-party servers, wherein the request comprises a plurality of parameters comprising a transfer amount of the funds, a type of the first financial account, a type of the second financial account, a location of the first financial account, a location of the second financial account, and a currency of the funds, and wherein the first and second financial accounts are associated with one or more servers that are different than the third-party server;
determine one or more available financial networks from the plurality of financial networks for which at least a subset of the plurality of parameters included in the request to transfer funds satisfy the rules indicating conditions for transferring funds through particular financial networks, and wherein the plurality of financial networks comprises more than one type of electronic funds transfer (ETF) network;
select a financial network of the one or more available financial networks over which to transfer the funds based on the at least one of the cost priority parameter or the speed priority parameter received from the user and financial-network data of the one or more available financial networks, wherein the financial-network data includes data associated with a cost or a speed of transferring funds using a particular financial network of the one or more available financial networks;
initiate a transfer of the funds over the selected financial network by sending a request to the selected financial network to transfer the funds from the first financial account to the second financial account; and
report, to the one or more third party servers, at least one of the selected financial network, a cost of the transfer, or confirmation that all necessary payment information to complete the transfer is available.

18. The non-transitory computer-readable storage medium of claim 17, wherein the plurality of parameters comprises at least one of data that identifies the first financial account, data that identifies the second financial account, an amount of the funds to be transferred, a currency associated with the first financial account, and a currency associated with the second financial account.

19. The non-transitory computer-readable storage medium of claim 17, wherein the cost priority parameter indicates that the funds are to be transferred at a lowest cost of the one or more available financial networks, such that to select the financial network, the one or more processors select a financial network, of the one or more available financial networks having the fastest speed.

20. The non-transitory computer-readable storage medium of claim 17, wherein the speed priority parameter indicates that the funds are to be transferred at a fastest speed of the one or more available financial networks, such that to select the financial network, the one or more processors select a financial network, of the one or more available financial networks having the fastest speed.

21. The computing device of claim 1, wherein each financial network of the plurality of financial networks is configured to, in response to receiving the request to transfer the funds from the first financial account to the second financial account, transfer the funds from the first financial account to the second financial account.

22. The computing device of claim 1, wherein the one or more processors are further configured to:
validate, prior to instructing the selected financial network to transfer the funds, the transfer of funds with one or more compliance agencies; and
report, to the one or more third party servers, the results of the validation.
